(19) United States
(12) Patent Application Publication
(10) Pub. No.: US 2013/0086214 A1
(43) Pub. Date: Apr. 4, 2013

(54) APPARATUS AND METHOD FOR SYNCHRONIZING APPLICATION DATA

(71) Applicant: Samsung Electronics Co., Ltd., Suwon-si (KR)

(72) Inventors: Soo-Yeon JUNG, Seoul (KR); Ho-Yeon Park, Seoul (KR); Hae-Young Jun, Seoul (KR)

(73) Assignee: Samsung Electronics Co., Ltd., Suwon-si (KR)

(21) Appl. No.: 13/630,847

(22) Filed: Sep. 28, 2012

(30) Foreign Application Priority Data
Sep. 30, 2011 (KR) 10-2011-0100002

(51) Int. Cl. G06F 15/16

(52) U.S. Cl. 709/217

(57) ABSTRACT

An apparatus and a method for synchronizing application data are provided. The method includes generating an application list for a first apparatus and transmitting an application list request message for requesting an application list of a second apparatus from the first apparatus to the second apparatus; receiving an application list response message from the second apparatus; and performing synchronization for an identical application between the first apparatus and the second apparatus.

### PRIORITY

This application claims priority under 35 U.S.C. §119(a) to a Korean Patent Application filed in the Korean Intellectual Property Office on Sep. 30, 2011 and assigned Serial No. 10-2011-0100002, the entire disclosure of which is incorporated herein by reference.

### BACKGROUND OF THE INVENTION

1. Field of the Invention

The present invention relates generally to an apparatus for synchronizing data, and more particularly, to an apparatus and a method for simultaneously synchronizing internal data for at least one application between mobile terminals.

2. Description of the Related Art

An information processing and a communication function of an enhanced mobile terminal have made use of mobile networks. Based on the increased use of a mobile apparatus function and development of wireless technologies, it has become common for a Personal Computer (PC) and a mobile apparatus to wirelessly share content such as an image or other data. With the improvement of performance of mobile apparatuses, allowing them to have the same processing speed as a PC, the concept of program, called an application, has emerged. An application is installed in an Operating System (OS) or a platform of an apparatus and then provides various services.

A user can use the applications in each apparatus by installing the same applications in various apparatuses. Likewise, a user may want to maintain a seamless user environment in separate apparatuses. Consequently, synchronization among the same applications installed on separate apparatuses is required.

For example, two mobile apparatuses for performing data synchronization perform data synchronization via a shared server. The shared server stores data based on a user's mobile apparatus. Thereafter, when data synchronization of the first and second mobile apparatuses is requested, the shared server searches data of each requested mobile apparatus and transmits the requested data to the first and second mobile apparatuses. The first and second mobile apparatuses implement data synchronization by updating mutual data.

Further, mobile apparatuses perform apparatus-to-apparatus synchronization by using a low communication speed of a technology such as Bluetooth® or an infrared communication so as to perform data synchronization between two mobile apparatuses without a shared server and external networks.

As described above, when it is impossible to use networks connected to a server, data synchronization between mobile apparatuses is impossible and for this synchronization, it is inconvenient in that there is an additional cost for constructing and managing a server.

Further, it is inconvenient that the time spent synchronizing is long because of the use of a low communication speed during synchronization.

Moreover, a synchronization scheme for using conventional Bluetooth® or IrDA® is an application-to-application synchronization scheme. Further, when a plurality of the same applications are installed in two mobile apparatuses, it is necessary to keep track of the progress of synchronization for each application in order to synchronize all applications. Therefore, there is a problem in that it is difficult to synchronize all applications at once.

### SUMMARY OF THE INVENTION

Accordingly, an aspect of the present invention is to provide an apparatus and a method for synchronizing data for applications installed in multiple mobile apparatuses by using a high speed communication.

In accordance with an aspect of the present invention, a first apparatus for synchronizing at least one application data is provided. The apparatus includes a communication module for establishing a communication connection with a second apparatus and transmitting data between the first apparatus and the second apparatus; a storage unit for storing an application, application data of the application, and first synchronization information used for synchronization; and a controller for, when synchronization is requested, generating an application list of the first apparatus and transmitting an application list request message for requesting an application list of the second apparatus to the second apparatus through the communication module, and when an application list response message including the application list of the second apparatus is received from the second apparatus, comparing the application list of the first apparatus with the application list of the second apparatus and performing synchronization for an identical application of the first apparatus and the second apparatus based on a result of the comparison.

In accordance with another aspect of the present invention, a method of synchronizing at least one application data is provided. The method includes generating an application list for a first apparatus and transmitting an application list request message for requesting an application list of a second apparatus from the first apparatus to the second apparatus; receiving an application list response message from the second apparatus; and performing synchronization for an identical application between the first apparatus and the second apparatus.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating first and second apparatuses according to an embodiment of the present invention;

FIG. 2 is a block diagram illustrating a controller according to an embodiment of the present invention;

FIG. 3 is a flowchart illustrating a process of performing application synchronization between a first apparatus and a second apparatus according to an embodiment of the present invention;

FIG. 4 is a flowchart illustrating a process of performing synchronization by transmitting application data to be synchronized with an application list according to an embodiment of the present invention;

FIG. 5 is a block diagram illustrating application list request and response messages according to an embodiment of the present invention;

FIG. 6 is a block diagram illustrating synchronization data request and response messages according to an embodiment of the present invention;

FIG. 7 is a block diagram illustrating an application information field of application list request or response messages in the case of having separate synchronization patterns and policies according to an embodiment of the present invention;

FIG. 8 is a block diagram illustrating an application data field of synchronization request or response messages in the case of having separate synchronization patterns and policies according to an embodiment of the present invention;

FIG. 9 is a flowchart illustrating a process of controlling a synchronization application to cause a synchronization controller to perform synchronization according to an embodiment of the present invention; and

FIG. 10 illustrates a synchronization application according to an embodiment of the present invention.

### DETAILED DESCRIPTION OF EMBODIMENTS OF THE PRESENT INVENTION

Hereinafter, embodiments of the present invention will be described in detail with reference to the accompanying drawings. In the following description and the accompanying drawings, a detailed explanation of known related functions and constitutions may be omitted to avoid unnecessarily obscuring the subject matter of the present invention.

FIG. 1 is a block diagram illustrating first and second apparatuses according to an embodiment of the present invention.

Referring to FIG. 1, a first apparatus 10 includes a communication connection module 100, a memory unit 110, and a controller 200.

The communication connection module 100 detects a second apparatus for synchronization, performs a communication connection with the detected second apparatus, and then transmits and receives data through a connected communication path.

The memory unit 110 includes at least one application, internal data for the at least one application, and synchronization information used for synchronization. The internal data for an application refers to data that can be synchronized, for example, scores for a game application, a schedule for a schedule application, a note for a memo application, an address book for an address book application, user environment setting information for an application, usage log for an application, or the like. Further, synchronization information includes a data list to be synchronized, synchronization patterns and policies, and standard synchronization data. The data list to be synchronized is information including data that is updated in internal data of an application in order to synchronize with a separate apparatus and the synchronization patterns and policies refers to information for representing which application data of which apparatus is synchronized between apparatuses. The synchronization standard data refers to data that is standard when synchronization between mobile terminals is performed. The synchronization standard data includes the number of content for applications, for example, time, scores of games, a video or music player application, a book application, or the like, and specific standard information of an application.

The second apparatus 20 having received the synchronization information performs data synchronization with synchronization patterns and policies prioritized between synchronization patterns and policies of the first apparatus 10 and synchronization patterns and policies of the second apparatus 20.

The controller 200 controls the general operations of the first apparatus 10, and in particular, detects the second apparatus 20 to be synchronized through the communication connection module 100 when synchronization is requested, and then performs a communication connection with the detected second apparatus 20.

The controller 200 collects synchronization information, such as a data item to be synchronized with at least one application operating on a platform, synchronization patterns and policies, and synchronization standard data, and then stores the collected information in the memory unit 110.

When there is a synchronization request, the controller 200 generates a list of at least one application installed in the first apparatus 10, establishes a communication connection with the second apparatus 20 and then transmits an application list request message including the generated application list of the first apparatus 10 to the second apparatus 20. The controller 200 further includes first synchronization information, which is synchronization information of the first apparatus 10, in the application list request message before transmitting the message.

When an application list response message including a list for at least one application identical to the application list of the first apparatus 10 among at least one application installed in the second apparatus 20 has been received from the second apparatus 20, the controller 200 determines whether there is application data to be transmitted to the second apparatus 20 based on the synchronization information. The transmitted application list response message also includes second synchronization information of the second apparatus 20.

In other words, the controller 200 compares the first synchronization information of the first apparatus 10 and the second synchronization information of the second apparatus 20 and then determines whether there is application data to be transmitted to the second apparatus 20 for synchronization based on a priority standard based on each synchronization information.

When there is application data to be transmitted to the second apparatus 20, the controller 200 transmits, to the second apparatus 20, a synchronization request message including the application data.

Specifically, when the first apparatus 10 and the second apparatus 20 have the same synchronization pattern and policy, the controller 200 checks application data to be transmitted to the second apparatus 20 and transmits a synchronization request message including the checked application data to the second apparatus 20.

When the first apparatus 10 and the second apparatus 20 have different synchronization patterns and policies, the controller 200 checks application data to be transmitted to the second apparatus 20 based on prioritized synchronization patterns and policies and transmits a synchronization request message including the checked application data to the second apparatus 20.

When a synchronization response message has been received from the second apparatus 20, the controller 200 determines whether specific application data for synchronization is included in the received synchronization response message. When the specific application data for synchronization is included in the received synchronization response message, the controller 200 updates the corresponding application data to the memory unit 110 and performs synchronization with the second apparatus 20.

For example, when a first application, a second application, a third application, and a fourth application are installed on the first apparatus 10 and the third application, the fourth application, a fifth application, and a sixth application are installed on the second apparatus 20, the applications installed in both apparatuses are the third application and the fourth application. The first apparatus and the second apparatus perform synchronization for the third and fourth applications. When new application data for the third application of the first apparatus 10 is added, the first apparatus 10 performs synchronization with the second apparatus 20 by transmitting the new application data for the third application to the second apparatus 20. This process is identically applied to the second apparatus 20.

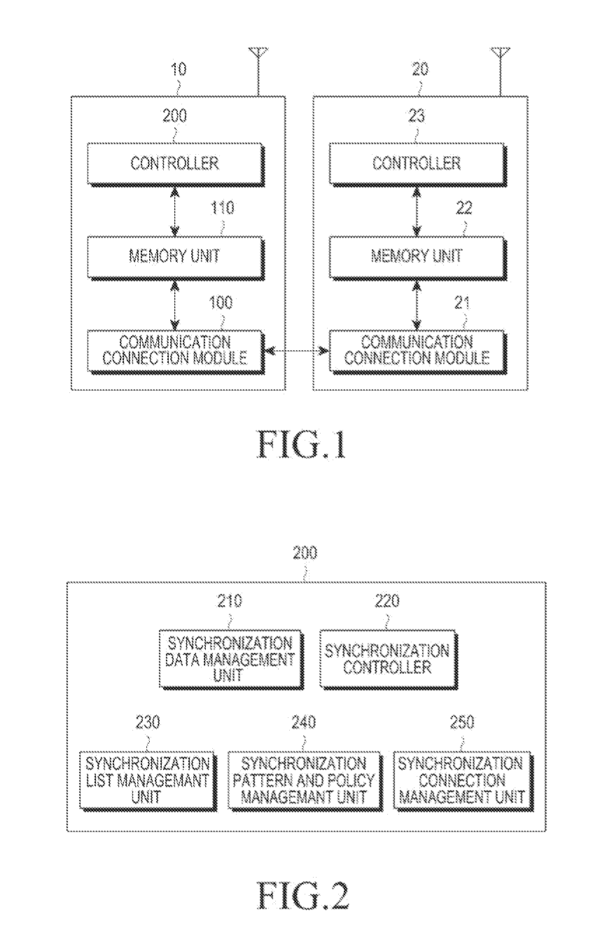

FIG. 2 is a block diagram illustrating a controller according to an embodiment of the present invention.

As shown in FIG. 2, the controller 200 includes a synchronization data management unit 210, a synchronization controller 220, a synchronization list management unit 230, synchronization pattern and policy management unit 240, and a synchronization connection management unit 250.

The synchronization data management unit 210 collects items to be synchronized with at least one application operating on a platform and synchronization patterns and policies, transmits the collected items to be synchronized to the synchronization list management unit 230, and transmits the synchronization patterns and policies to the synchronization pattern and policy management unit 240.

During synchronization, the synchronization data management unit 210 performs synchronization for an application to be synchronized, updates application data received for synchronization, and transmits updated content to a corresponding application.

The synchronization controller 220 compares synchronization data for identical applications in each apparatus with synchronization data received from another apparatus, and then informs users of the result of the comparison through a synchronization application enabling communicating with the users. Moreover, the synchronization controller 220 displays a list of at least one application to be synchronized and a synchronization item for the at least one application on a screen of an apparatus through the synchronization application.

The synchronization list management unit 230 manages a data item to be synchronized for each application.

The synchronization pattern and policy management unit 240 manages synchronization patterns and policies for each application.

The synchronization connection management unit 250 is connected to the synchronization controller 220 and communicates with a communication connection module in an apparatus.

The second apparatus 20, according to an embodiment of the present invention, includes a communication connection module 21, a memory unit 22, and a controller 23.

The communication connection module 21, which is similar to the communication connection module 100 of the first apparatus 10, as described above, detects the first apparatus 10 for synchronization, establishes a communication connection with the detected first apparatus 10, and transmits or receives data through a connected communication path.

The memory unit 22 is similar to the memory unit 110 of the first apparatus 10, as described above, and includes at least one application, internal data for the at least one corresponding application, and synchronization information used for the synchronization.

The controller 23 is similar to the controller 200 of the first apparatus 10. The controller 23 controls general operations of the second apparatus 20 and, in particular, performs a communication connection with the first apparatus 10 in order to synchronize, through the communication connection module 21, when synchronization is requested.

The controller 23 collects second synchronization information including data items to be synchronized with at least one application operating on a platform, synchronization patterns and policies, and synchronization standard data, and stores the collected second synchronization information in the memory unit 22.

When an application list request message including an application list of the first apparatus 10 has been received, the controller 23 determines whether the apparatuses have one or more identical application by comparing the application list of the first apparatus 10 and the application list of the second apparatus 20.

The controller 23 generates an identical application list for identical applications and transmits an application list response message including the generated identical application list to the first apparatus 10. The controller 23 further includes second synchronization information, which is the synchronization information of the second mobile terminal 20 in the transmitted application list response message.

When a synchronization request message is received from the first apparatus 10, the controller 23 determines whether application data to be updated is included in the received synchronization request message. If application data to be updated is included, the controller 23 updates the application data to the memory unit 22 and performs synchronization with the first apparatus 10.

The controller 23 then compares the synchronization information of the first apparatus 10 and the synchronization information of the second apparatus 20 and determines whether there is application data to be transmitted to the first apparatus 10 for synchronization based on a priority standard according to each synchronization information.

When there is application data to be transmitted to the first apparatus 10, the controller 23 transmits a synchronization response message including corresponding application data to the first apparatus 10.

When there is no application data to be transmitted to the first apparatus 10, the controller 23 transmits a synchronization response message in response to a synchronization request message to the first apparatus 10 and then terminates the synchronization process.

As described above, because the present invention shares a list of at least one application identically installed in both apparatuses and performs data synchronization for identical applications, it is possible to reduce the time spent on synchronization by performing synchronization for at least one application at once.

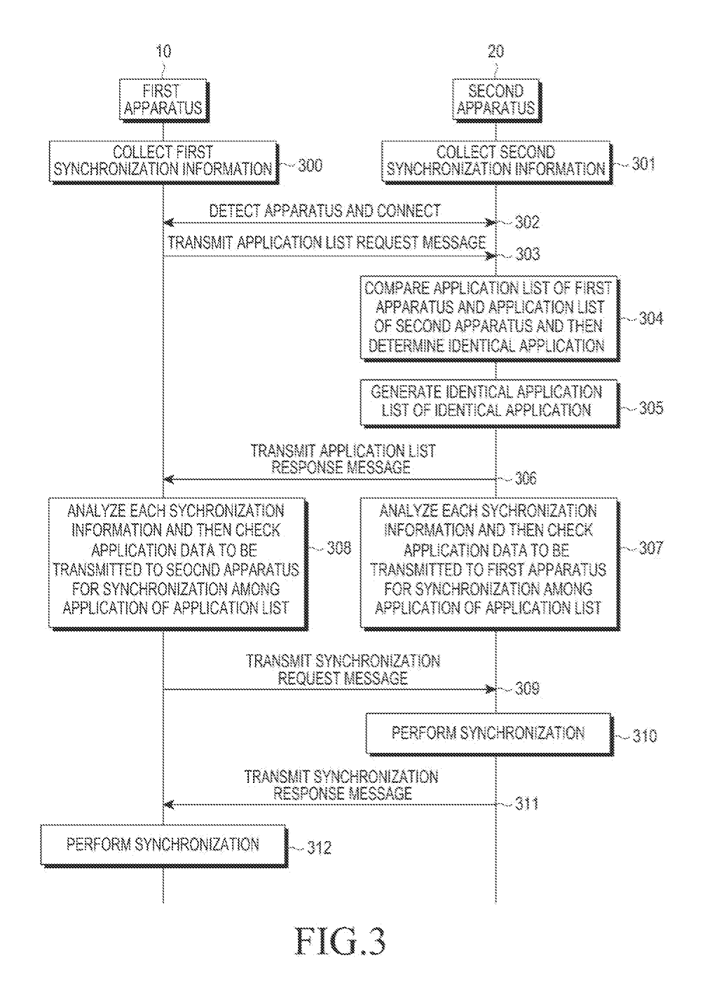

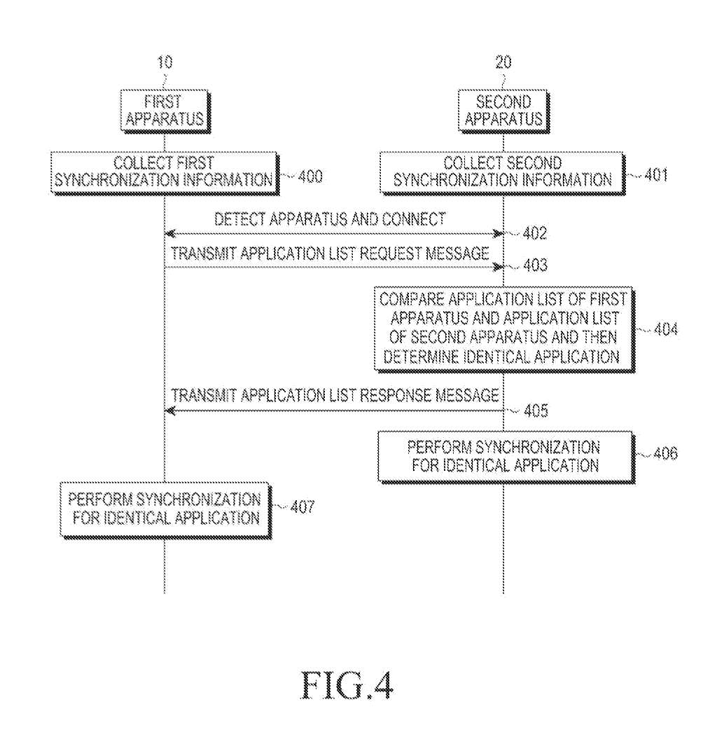

FIG. 3 is a flowchart illustrating a process of performing application synchronization between a first apparatus and a second apparatus according to an embodiment of the present invention.

Referring to FIG. 3, in step 300, the first apparatus 10 collects first synchronization information including data items to be synchronized for at least one application operating on a platform, synchronization patterns and policies, and synchronization standard data.

In step 301, the second apparatus 20 collects second synchronization information including data items to be synchronized for at least one application operating on a platform, synchronization patterns and policies, and synchronization standard data.

In step 302, the first apparatus 10 and the second apparatus 20 detect each other and perform a communication connection. The communication connection may be achieved by a new communication method such as Wi-Fi direct or 802.11 ad (i.e., “WiGig”), or a device-to-device communication.

In step 303, the first apparatus 10 transmits an application list request message including the first synchronization information together with an application list for at least one application to the second apparatus 20.

In step 304, the second apparatus 20 compares the application list of the first apparatus 10 and the application list of the second apparatus 20 included in a received application list request message and determines whether both application lists include an identical application or identical applications.

When an identical application or identical applications exist, the second apparatus 20 generates an identical application list of identical applications in step 305.

In step 306, the second apparatus 20 transmits an application list response message including the generated identical application list to the first apparatus 10.

In step 307, the second apparatus 20 analyzes the first synchronization information and the second synchronization information and determines whether there is application data to be transmitted to the first apparatus 10 for synchronization among applications of the application list.

In step 308, the first apparatus 10 analyzes the first synchronization information and the second synchronization information and determines whether there is application data to be transmitted to the second apparatus 20 for synchronization among applications of the identical application list.

Specifically, the first apparatus 10 analyzes synchronization patterns and policies of the first apparatus 10 and synchronization patterns and policies of the second apparatus 20 within the first synchronization information and the second synchronization information and determines a process by which synchronization is to be performed. This process is identically applied to the second apparatus 20.

TABLE 1

| | Types of synchronization | |
|---|---|---|
| Value | patterns and policy | Description |
| 0 | User Selection | Receiving an input before |
| | | synchronization, from a user, as to |
| | | which data of an apparatus is to be |
| | | synchronized into, and then |
| | | synchronizing |
| 1 | Merge | Synchronizing by combining |
| | | application data of two apparatuses |
| 2 | Criteria Comparison | Synchronizing into application data |
| | | having the highest priority through set |
| | | condition comparison performance |
| . . . | . . . | . . . |

Table 1 shows types and descriptions for synchronization patterns and policies according to an embodiment of the present invention.

In the case of having different synchronization patterns and policies for an identical application, each apparatus needs to determine the synchronization pattern and policy to which each apparatus will give a priority for performing the synchronization.

To this end, in the present invention, priority values are assigned to different types of the synchronization patterns and policies so that the synchronization may be performed in an order from the highest priority value to the lowest priority value. For example, as shown in Table 1, the “User Selection” having a priority value 0 is applied in the highest priority in sequence, the “Merge” having a priority value 1 is applied in the next priority, and the “Criteria Comparison” having a priority value 2 is applied in the next highest priority. Further, in the present invention, the “User Selection” can be applied without condition.

For example, when the synchronization patterns and policies of the first apparatus 10 is “User Selection” and the synchronization patterns and policies of the second apparatus 20 is “Merge”, the first apparatus 10 determines that the synchronization should be performed by the “User Selection” that has the highest priority. Thereafter, the first apparatus 10 displays an application list of applications that can be synchronized through the synchronization application, includes data for an application selected by a user in a synchronization request message, and then transmits the message to the second apparatus 20.

In step 309, when there is application data to be transmitted, the first apparatus 10 transmits a synchronization request message including corresponding application to the second apparatus 20. When there is no application data to be transmitted, the first apparatus 10 transmits only the synchronization request message to the second apparatus 20.

In step 310, when application data is included in the received synchronization request message, the second apparatus 20 updates the received application data to the memory unit 22 and performs synchronization with the first apparatus 10.

In step 311, when there is application data to be transmitted, the second apparatus 20 transmits a synchronization response message including the corresponding application to the first apparatus 10. When there is no application data to be transmitted, the second apparatus 20 transmits the synchronization response message to the first apparatus 10.

In step 312, when application data is included in a received synchronization response message, the first apparatus 10 updates the received application data to the memory unit 110 and performs synchronization with the second apparatus 20.

As described above, because a list of at least one application identically installed in both apparatuses is shared and data synchronization for identical applications is performed, it is possible to reduce time spent on synchronization by performing synchronization for at least one application simultaneously.

FIG. 4 is a flowchart illustrating a process of performing synchronization by transmitting application data to be synchronized along with an application list according to an embodiment of the present invention.

When the patterns and policies as described above is “Merge”, the first apparatus 10 and the second apparatus 20 exchange their application data with one another in order to merge the application data of the first apparatus 10 with the application data of the second apparatus 20.

With respect to the embodiment as described above, a case in which synchronization pattern and policy for at least one application is “Merge” will be described below as an example. In the embodiment of the present invention, it is assumed that the first apparatus 10 stores first application data for a specific application and the second apparatus 20 stores second application data for another specific application.

Referring to FIG. 4, the first apparatus 10 collects first synchronization information including data items to be synchronized for at least one application operating on a platform, synchronization patterns and policies, and synchronization standard data in step 400.

In step 401, the second apparatus 20 also collects second synchronization information including data items to be synchronized for at least one application operating on a platform, synchronization patterns and policies, and synchronization standard data.

In step 402, the first apparatus 10 and the second apparatus 20 detect one another and establish a communication connection. The communication connection is achieved by a Wi-Fi direct.

In step 403, the first apparatus 10 transmits an application list request message including an application list of at least one application and the first synchronization information to the second apparatus 20. Since the synchronization pattern and policy for a specific application within the first synchronization information is “Merge”, the synchronization request message further includes the first application data for the specific application.

In step 404, the second apparatus 20 compares the application list of the first apparatus 10 and the application list of the second apparatus 20 included in the received application list request message and determines whether an identical application is included in both application lists.

In step 405, the second apparatus 20 transmits a synchronization response message including the second application data for a specific application desired to be transmitted to the first apparatus 10.

In this event, the second application data is application data that the second apparatus 20 has stored for a specific application before the synchronization.

In step 406, when there is an identical application, the second apparatus 20 determines whether the specific application is included in the identical application. When the specific application is included, synchronization is performed by merging the first application data for the specific application with the second application data and then storing the data.

In step 407, the first apparatus 10 performs synchronization by merging the second application data included in the received synchronization response message with the first application data and then storing the merged data.

While application data for a specific application between apparatuses is synchronized in the above description according to an embodiment of the present invention, it is possible to synchronize application data for a plurality of applications. For example, when synchronization patterns and policies for a plurality of the applications is “Merge”, application data for the plurality of applications that the apparatuses have are exchanged with one another and are synchronized so as to enable the apparatuses to have merged application data. As described above, in the present invention, the apparatuses share a list of at least one application and perform data synchronization for identical applications, which makes it possible to perform synchronization for at least one application at once and thereby reduce time spent on synchronization.

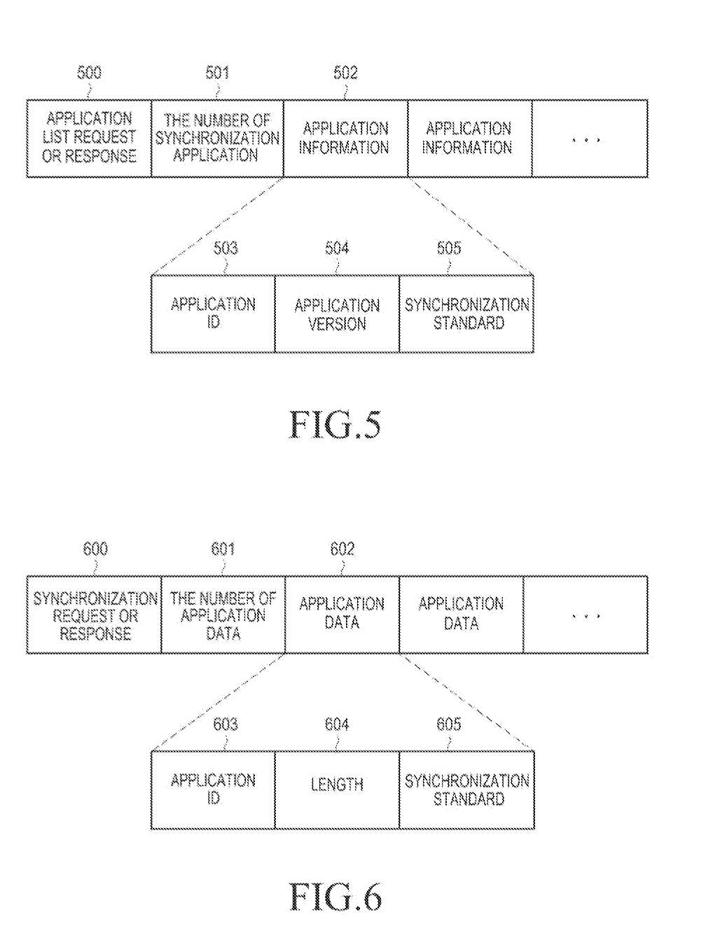

FIG. 5 is a block diagram illustrating application list request and response messages according to an embodiment of the present invention.

Referring to FIG. 5, an application list request or response message includes an application list request or response field 500 indicating the application list request or response message, a synchronization application field 501 indicating the number of applications included in an application list, and an application information field 502 indicating application information. Further, the application list request or response message includes at least one application information field 502 as described above.

Specifically, the application list request or response field 500 includes a message ID indicating that the present message is a message for requesting or responding to application synchronization.

The synchronization application field 501 includes the number of applications to be transmitted in order to synchronize applications in a corresponding message. A value of this field is equal to the total number of application information.

The application information field 502 includes application information to be synchronized, which is selectively included and transmitted. For example, when the first apparatus 10 has three applications, the first apparatus 10 includes information about only one application among the three applications in the application information field 502 and transmits the message including the application information field to the second apparatus 20. When two apparatuses do not have applications that can be synchronized, the list response message does not use an application information field. Therefore, the synchronization application field 501 is set to “0”.

As used herein, the application information field 502 includes an application ID field 503 indicating an application ID for identifying applications, an application version field 504 indicating version information of applications, and a synchronization standard field 505 indicating synchronization standard value used to compare conditions for synchronization.

Specifically, the application ID field 503 includes a unique ID of an application. Thus, the first apparatus 10 or the second apparatus 20 determines whether there is an application capable of synchronizing between the two apparatuses by checking an application ID.

The application version field 504 includes information indicating a version of an application.

The synchronization standard field 505 includes data that is a standard for synchronization, such as information of time and scores.

For example, time data in the synchronization standard data indicates information for a time at which the application has been finally updated. When two apparatuses want to perform synchronization with the most recently updated application data, the time data is utilized.

FIG. 6 is a block diagram illustrating a synchronization data request or response message according to an embodiment of the present invention.

Referring to FIG. 6, a synchronization data request or response message includes a synchronization data request or response field 600 indicating a synchronization request or response message, an application data number field 601 indicating the number of applications included in an application list, and an application data field 602 indicating application data. Further, a synchronization data request and response message may include at least one application data field 602.

The application data field 602 includes a field 603 for representing an application ID for identifying applications, an application length field 604 for representing a length of an application information field, and a synchronization data field 605 for representing synchronization data to be transmitted for synchronization.

FIGS. 5 and 6 illustrate a case in which it is assumed that synchronization patterns and policies are identical with respect to each identical application between the apparatuses.

When identical applications of two apparatuses have different synchronization patterns and policies, each apparatus further includes information about synchronization patterns and policies of applications in a message and then transmit the message.

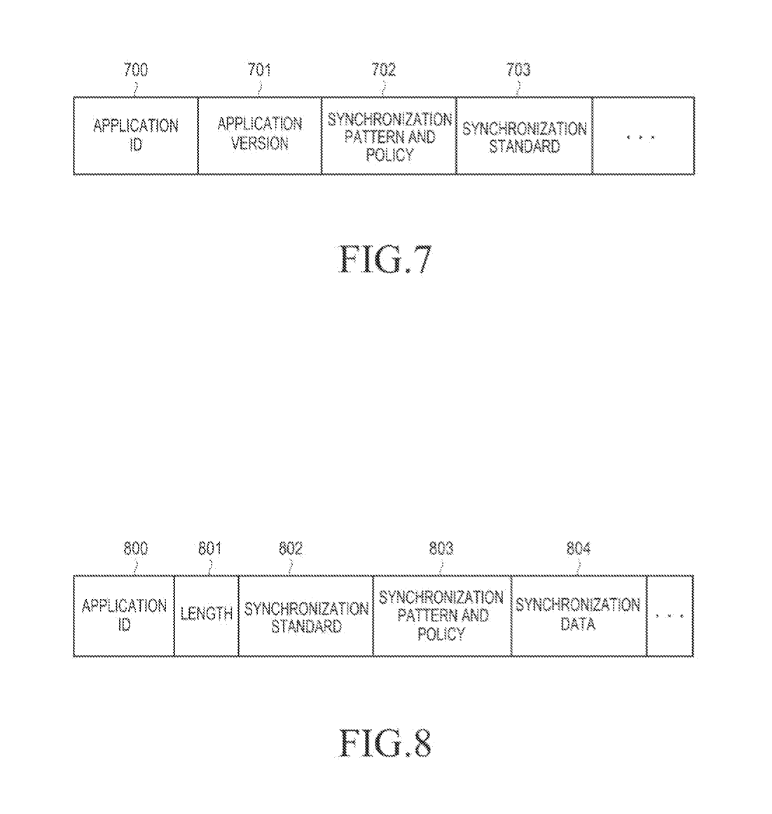

FIG. 7 is a block diagram illustrating an application information field of an application list request or response messages in the case of having different synchronization patterns and policies according to an embodiment of the present invention.

An application information field of FIG. 7 includes an application ID field 700, an application version field 701, and a synchronization standard field 703, like the application data field described above with reference to FIG. 5, and a synchronization pattern and policy field 702 for representing synchronization patterns and policies.

FIG. 8 is a block diagram illustrating an application data field of synchronization request or response messages in the case of having different synchronization patterns and policies according to an embodiment of the present invention.

The application data field of FIG. 8 includes an application ID field 800, an application data length field 801, a synchronization standard field 802, and a synchronization data field 804, like the application data field described with reference to FIG. 6, and a synchronization pattern and policy field 803 for representing synchronization patterns and policies.

The synchronization pattern and policy field includes information of policies that will be applied for synchronization of corresponding applications. The policy includes a method of synchronization with the most recently updated data, a method of synchronization with data of a counterpart apparatus, a method of synchronization with data of a current apparatus, a method of synchronization with data selected by a user through a user input, a method of synchronization with new data obtained by integrating changed parts in both apparatuses' data, a method in which an application is synchronized by applying separate synchronization policies according to each data to be synchronized, or the like.

The transmitted synchronization pattern and policy field includes only information of at least one policy to be used by the current apparatus or includes information of all synchronization patterns and policies, which enable an application having an application ID of the present apparatus to support synchronization.

For example, when a response message is transmitted, if an apparatus agrees with synchronization patterns and policies included in a request message, information of the synchronization patterns and policies included in the request message is included in a synchronization pattern and policy field of the response message. If an apparatus does not agree with the synchronization patterns and policies included in a request message, information of the synchronization patterns and policies desired to be used in the current apparatus is included in the synchronization pattern and policy field of the response message.

Moreover, when different values are included in the synchronization pattern and policy field of the request message and the synchronization pattern and policy field of the response message, additional information on the reason they are different is included in an application information field of a request or response message.

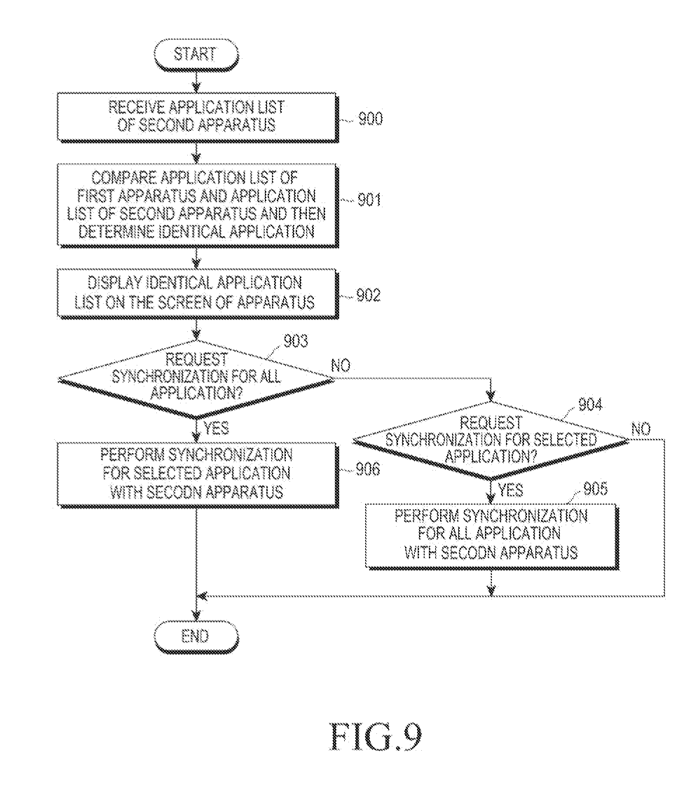

FIG. 9 is a flowchart illustrating a process of controlling a synchronization application in order to cause a synchronization controller to perform synchronization according to an embodiment of the present invention.

In step 900, a synchronization controller 220 receives an application list of the second apparatus 20.

In step 901, the synchronization controller 220 determines an identical application list by comparing an application list of the first apparatus 10 with the application list of the second apparatus 20.

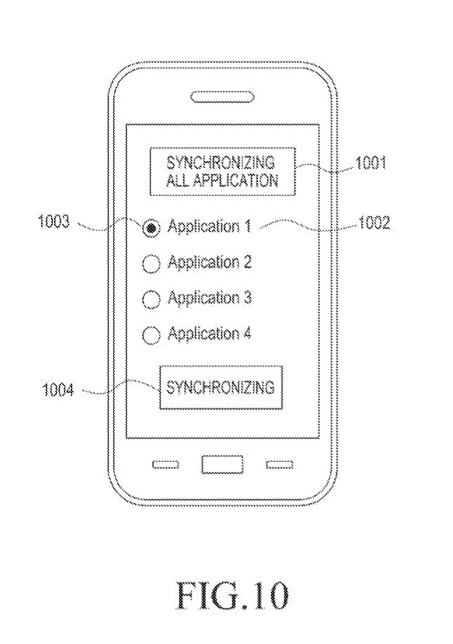

In step 902, the synchronization controller 220 displays the identical application list by using a synchronization application in a screen. A displayed screen is displayed as shown in FIG. 10.

FIG. 10 illustrates a synchronization application according to an embodiment of the present invention.

Each step will be described with reference to FIG. 10. In step 903, the synchronization controller 220 determines whether there is an input for “synchronizing all applications” 1001 of FIG. 10 by a user. Then, if the input exists, the synchronization controller 220 proceeds to step 906. If the input does not exist, the synchronization controller 220 proceeds to step 904 to determine whether there is a synchronization request 104 for a selected application 1003.

If it is determined that there is a synchronizing request 1004, the synchronization controller 220 proceeds to step 905 in which the synchronization controller 220 synchronizes with the second apparatus 20 for the selected application 1003, and then terminates a synchronization process.

The synchronization controller 220 having proceeded from step 903 to step 906 performs synchronization with the second apparatus 20 for all applications 1002 according to the request, and then terminates the synchronization process.

As described above, because apparatuses share a list of at least one application identically installed in both apparatuses and perform data synchronization for identical applications, it is possible to perform synchronization for at least one application at once and thereby reduce time spent on synchronization.

While the present invention has been shown and described with reference to certain embodiments and drawings of the portable terminal, it will be understood by those skilled in the art that various changes in form and details may be made therein without departing from the spirit and scope of the invention as defined by the appended claims and their equivalents.

What is claimed is:

1. A first apparatus for synchronizing application data, the apparatus comprising:
a communication module for establishing a communication connection with a second apparatus and transmitting data between the first apparatus and the second apparatus;
a storage unit for storing an application, application data of the application, and first synchronization information used for synchronization; and
a controller for, when synchronization is requested, generating an application list of the first apparatus and transmitting an application list request message for requesting an application list of the second apparatus to the second apparatus through the communication module, and when an application list response message including the application list of the second apparatus is received from the second apparatus, comparing the application list of the first apparatus with the application list of the second apparatus and performing synchronization for an identical application of the first apparatus and the second apparatus based on a result of the comparison.

2. The apparatus of claim 1, wherein the first synchronization information comprises a data item to be synchronized for the application and synchronization standard data.

3. The apparatus of claim 2, wherein the first synchronization information further comprises synchronization patterns and policies.

4. The apparatus of claim 2, wherein the application list request message further comprises the first synchronization information.

5. The apparatus of claim 3, wherein the application list response message further comprises the second synchronization information of the second apparatus.

6. The apparatus of claim 1, wherein the application list of the second apparatus includes a list of one or more applications identical to those of the application list of the first apparatus.

7. The apparatus of claim 2, wherein, during synchronization, the controller compares synchronization patterns and policies of the first apparatus with synchronization patterns and policies of the second apparatus and determines whether there is application data to be synchronized for the identical application, and when there is application data to be synchronized, the controller transmits a synchronization request message including the application data to be synchronized to the second apparatus.

8. The apparatus of claim 6, wherein, when the synchronization response message has been received from the second apparatus, the controller determines whether application data to be synchronized is included in the received synchronization response message, and when the application data to be synchronized is included, the controller updates the application data to be synchronized in the storage unit.

9. The apparatus of claim 1, wherein, when the application list request message is transmitted to the second apparatus, the controller analyzes synchronization patterns and policies of the first apparatus and further includes the application data to be synchronized according to an analyzed result in the transmitted application list request message before transmitting the message.

10. A method of synchronizing application data, the method comprising:
generating an application list for a first apparatus and transmitting an application list request message for requesting an application list of a second apparatus from the first apparatus to the second apparatus;
receiving an application list response message from the second apparatus; and
performing synchronization for an identical application between the first apparatus and the second apparatus.

11. The method of claim 10, further comprising:
when synchronization is requested, detecting the second apparatus and establishing a communication connection with the second apparatus.

12. The method of claim 10, wherein the application list request message further comprises a first synchronization information.

13. The method of claim 12, wherein the first synchronization information comprises data items to be synchronized for the application and synchronization standard data.

14. The method of claim 13, wherein the first synchronization information comprises synchronization patterns and policies.

15. The method of claim 14, wherein the application list response message further comprises the second synchronization information of the second apparatus.

16. The method of claim 10, wherein the application list of the second apparatus is a list of one or more applications identical to those of the application list of the first apparatus.

17. The method of claim 12, wherein performing the synchronization for the application comprises:
comparing synchronization patterns and policies of the first apparatus with synchronization patterns and policies of the second apparatus and determining whether there is application data to be synchronized for the identical application; and
when there is the application data to be synchronized, transmitting a synchronization request message including the application data to be synchronized to the second apparatus.

18. The method of claim 17, further comprising:
when the synchronization response message has been received from the second apparatus, determining whether the application data to be synchronized is included in the received synchronization response message; and
when the application data to be synchronized is included, updating the application to be synchronized.

19. The method of claim 10, wherein transmitting of the application list request message to the second apparatus comprises:
analyzing the synchronization patterns and policies of the first apparatus; and
including the application data to be synchronized in the application list request message according to an analyzed result and transmitting the application list request message.
